(19) United States
(12) Patent Application Publication
(10) Pub. No.: US 2008/0112776 A1
(43) Pub. Date: May 15, 2008

(54) Quick assembling nut

(75) Inventor: Li-Guo Yan, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Globe Union Industrial Corp., Taichung (TW)

(21) Appl. No.: 11/598,630

(22) Filed: Nov. 14, 2006

(51) Int. Cl. F16B 37/08

(52) U.S. Cl. 411/433

(57) ABSTRACT

A quick assembling nut of present invention comprising: a main part provides with a penetrating hole. There are two pivot seats on the wall of the penetrating hole. Two swing arms pivot on the pivot seat. One end of the swing arm bends to one side to form an against portion. The other end of the swing arm provides a grip portion. The grip portion has an arc wall with threads thereon. Those two arc wall are placed face to face and then those two against portions bend outward of the main part. Two elastic members are placed individually in the pivot seat and between the swing arm and the main part for providing a tension to keep those two against portions stay away from the pivot seat.

### BACKGROUND OF THE INVENTION

1. Field of the Invention

The present invention relates to the assembly of equipments especially to a quick assembling nut.

2. Description of the Related Art

A mostly usually way is using a nut to coordinate with the equipment if people want to assemble equipments with threads on it to a fixed place. For example, when people want to fix a faucet on a table, people usually put the faucet on one side of the table first. Then, a nut screws on the thread of the faucet at the other side of the table. So, the faucet can be secured on the table by the nut and the threads of the faucet. The disadvantage of these structures is wasting a lot of time for rotating the nut. As the faucet has threads longer, the rotating time wastes more.

### SUMMARY OF THE INVENTION

The object of the present invention is to provide a quick assembling nut that can assemble quickly and easily.

To achieve the object of the present invention, the quick assembling nut in present invention, comprising:

### BRIEF DESCRIPTION OF THE DRAWINGS

FIG. 1 is an appearance view of the first embodiment of present invention;

FIG. 2 is an exploded view of the first embodiment of present invention;

FIG. 3 is a section view of the first embodiment of present invention;

FIG. 4 and FIG. 5 is diagram of the first embodiment of present invention;

FIG. 6 is an appearance view of the second embodiment of present invention;

FIG. 7 is an exploded view of the second embodiment of present invention;

FIG. 8 is a section view of the second embodiment of present invention;

FIG. 9 and FIG. 10 is diagram of the second embodiment of present invention.

### DETAILED DESCRIPTION OF THE INVENTION

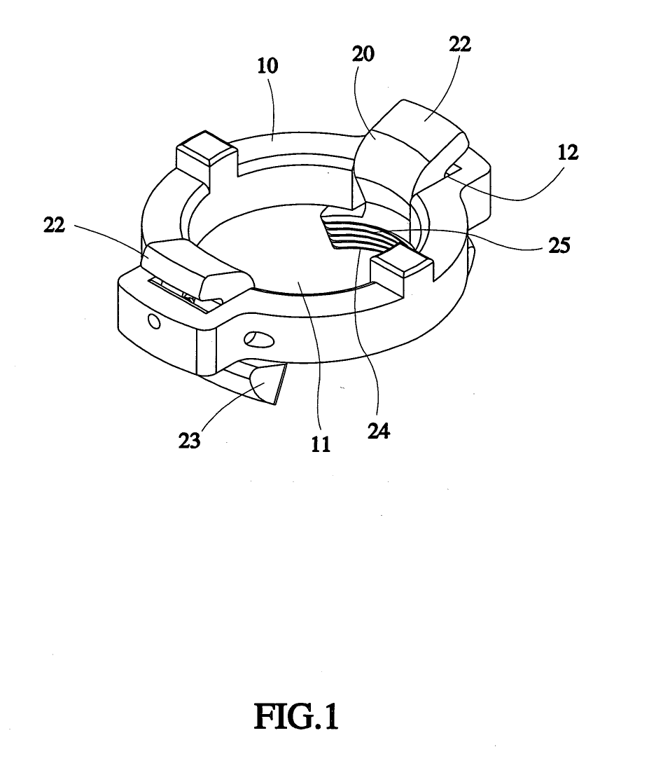

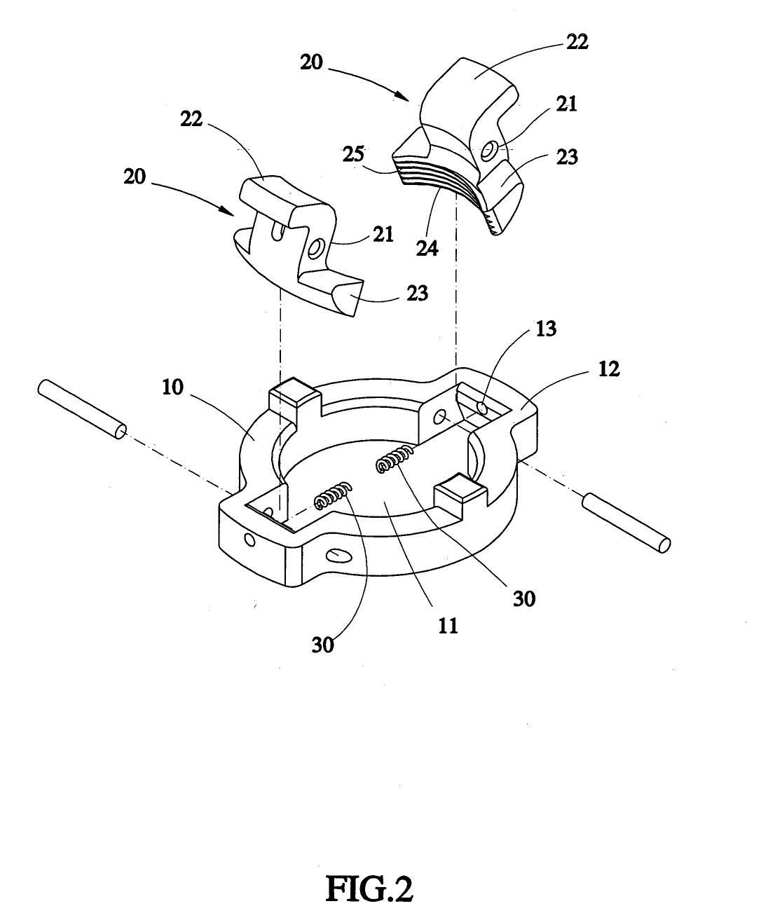

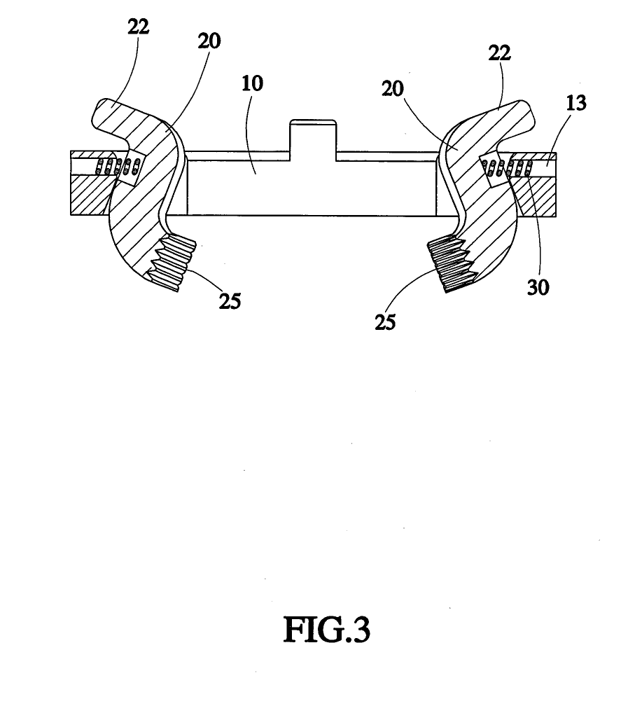

Referring to FIG. 1 to FIG. 3, a quick assembling nut of the first embodiment of present invention, comprising: a main part 10, two swing arms 20 and two elastic member 30.

The main part 10 provides with a penetrating hole 11. There are two pivot seats 12 on the wall of the penetrating hole 11. The pivot seat is an indent in this embodiment.

Two side of the swing arm 20 provides a pivot portion 21. One end of the swing arm bends to one side to form an against portion 22. The other end of the swing arm provides a grip portion 23. The grip portion has an arc wall 24 with threads 25 on it. These swing arm 20 pivot on the pivot seat of the main part 10 by the pivot portion 22. The against portion 22 and the grip portion 23 of a swing arm 20 both protrudes out of the main part 10. Those two arc wall 24 at the grip portion 23 of swing arms 20 are placed face to face and then those two against portions 22 bend outward of the main part 10.

Those two elastic members 30 are placed individually in the pivot seat 12 of the main part 10 and between the swing arm 20 and the main part 10 for providing a tension to keep those two grip portions 23 open in peacetime. Those two elastic members 30 are spring and place in a receiving hole 13 in the pivot seat 12 of main part 10 in this embodiment. One end of the elastic member 30 is against on the bottom of the receiving hole 13 and the other end protrudes out of the receiving hole 13 and is against on the swing arm 20. By the way, those elastic members 30 can keep those two grip portions 23 open in peacetime.

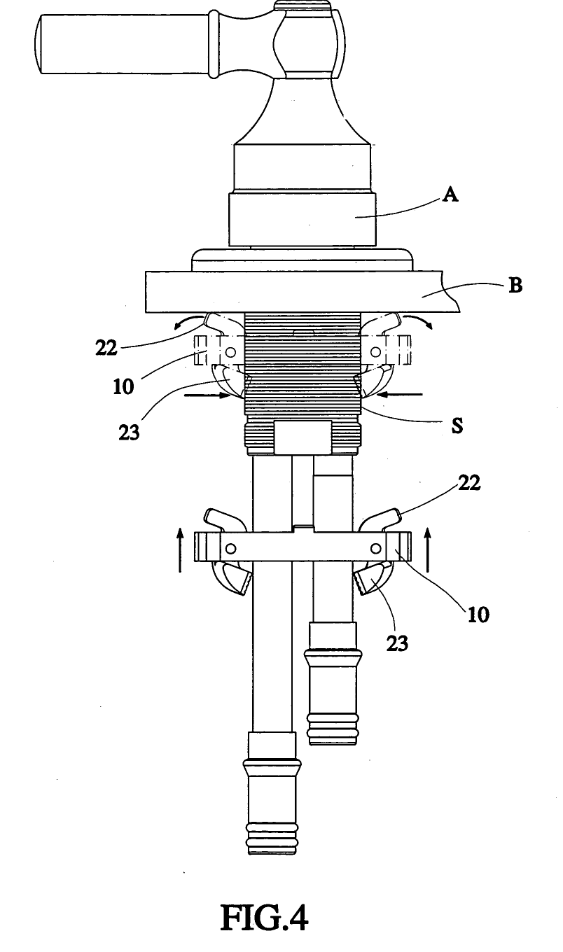

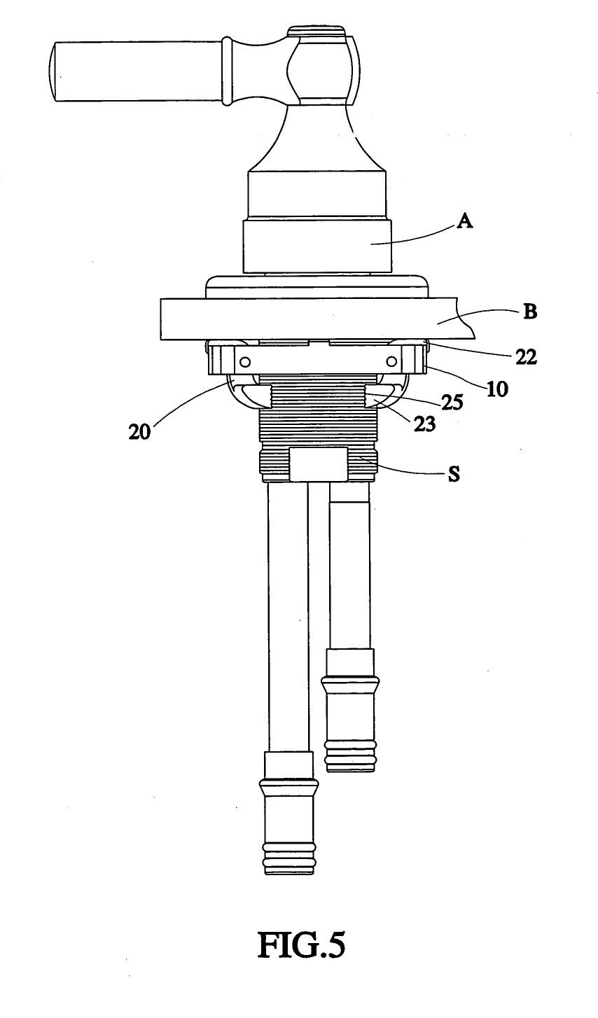

As those structures disclosed in the first embodiment of present invention, the assembly method is same as prior art in the beginning. Referring to FIG. 4 and FIG. 5, the first assembly step is inserting a target object A with threads S on it into a hole on a table B. Slipping the main part 10 on the threads end of the target object A and make the threads end of the target object A goes into the penetrating hole 11. The different between prior art and present invention is the main part 10 can move forward to the table B easily and quickly in the beginning and the threads of the target object A still not influence the main part 10 so far. The main part 10 can move directly and quickly to the table B until those against portions 22 of the swing arms 20 are against on the bottom side of the table B. Those against portion 22 will be pushed out du to the resistance from the table B and the swing arms 20 will swing as the pivot portion is a rotational axis and press the elastic member 30 and also make the grip portions 23 move forward to the thread of the target object A. As the main part 10 moves closer to the table B, the against portions 22 of the swing arms 20 will be pushed to close to the pivot seat 12. So, the grip portion 23 will clip the target object A more tightly and gear into the threads S finally. At this mount, the main part 10 can not move quickly to the table B any more but rotation because of the grip portions 23 gear into the threads of the target object A. The grip portion 23 and the threads S of the target object A will push the main part 10 moving along the direction of the threads by rotating the main part 10. The grip portions 23 will clip the threads S of the target object A tighter as the main part 10 gets more closer to the table B. As a result, the main part 10 can provide the same function as prior art and secure the target object A on the table B easily and quickly.

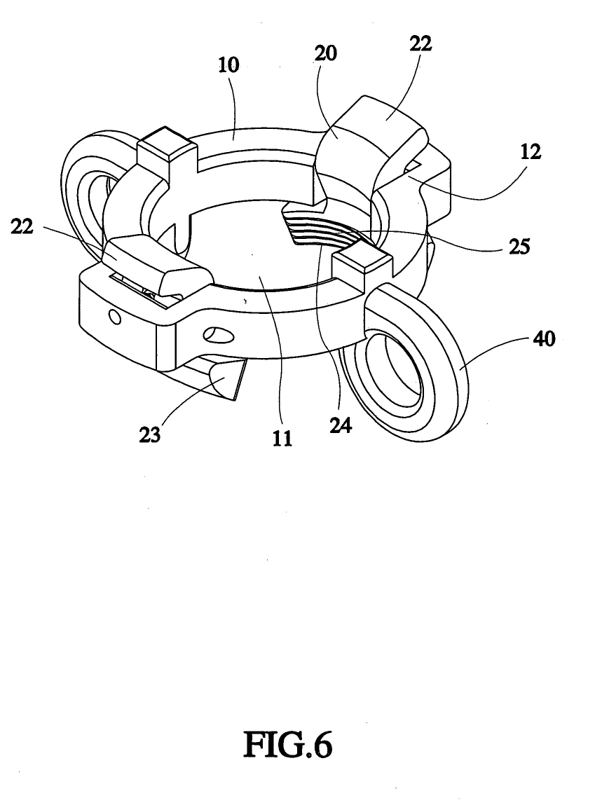

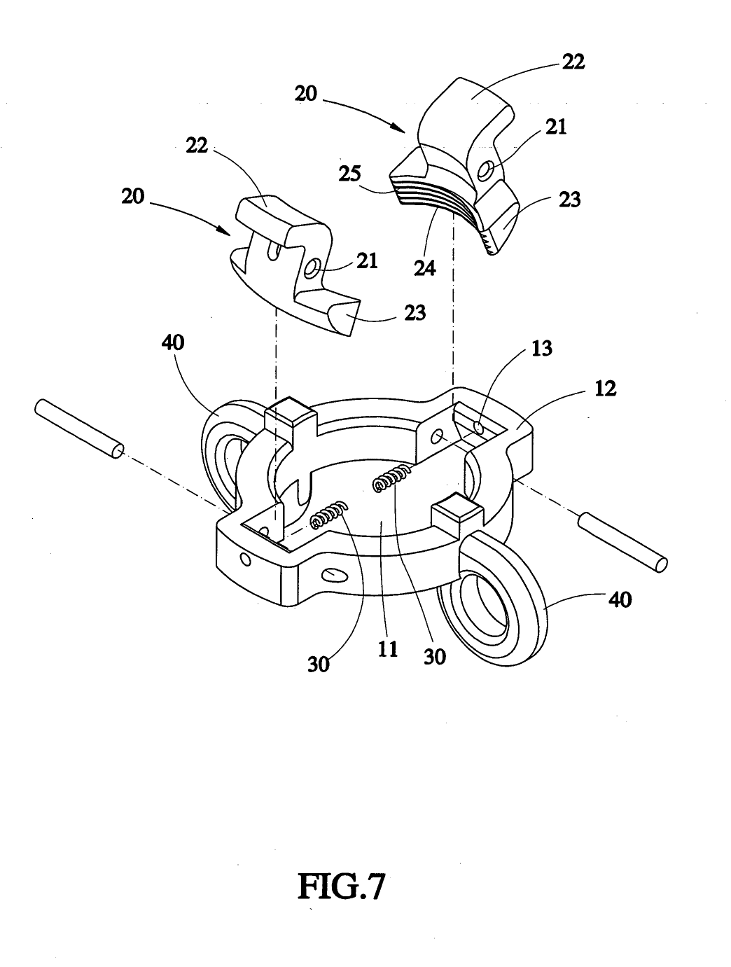

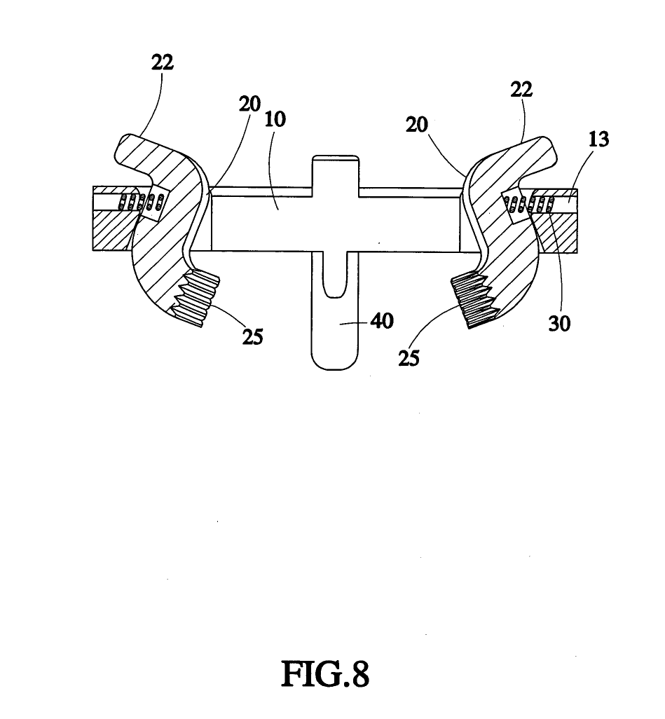

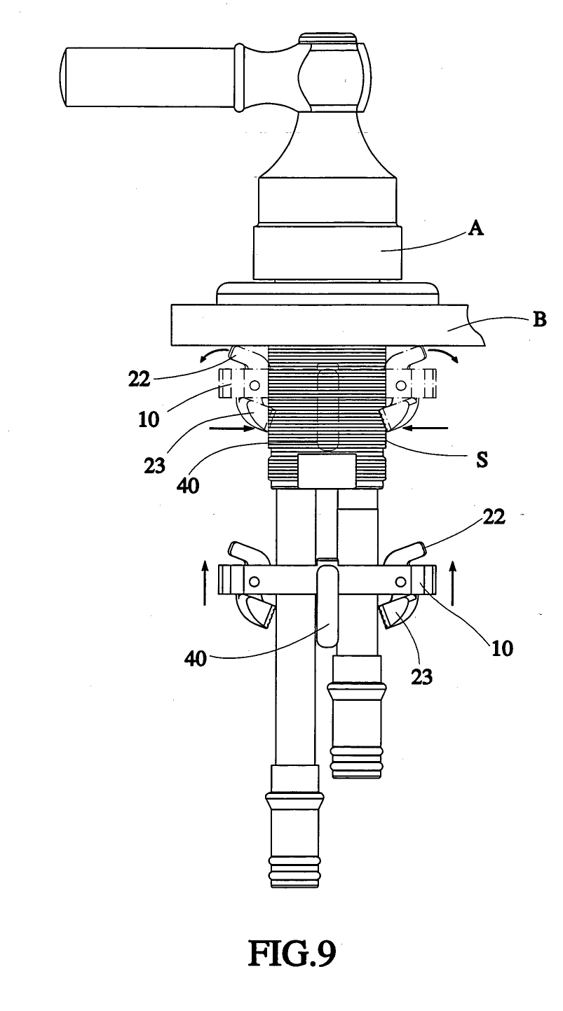

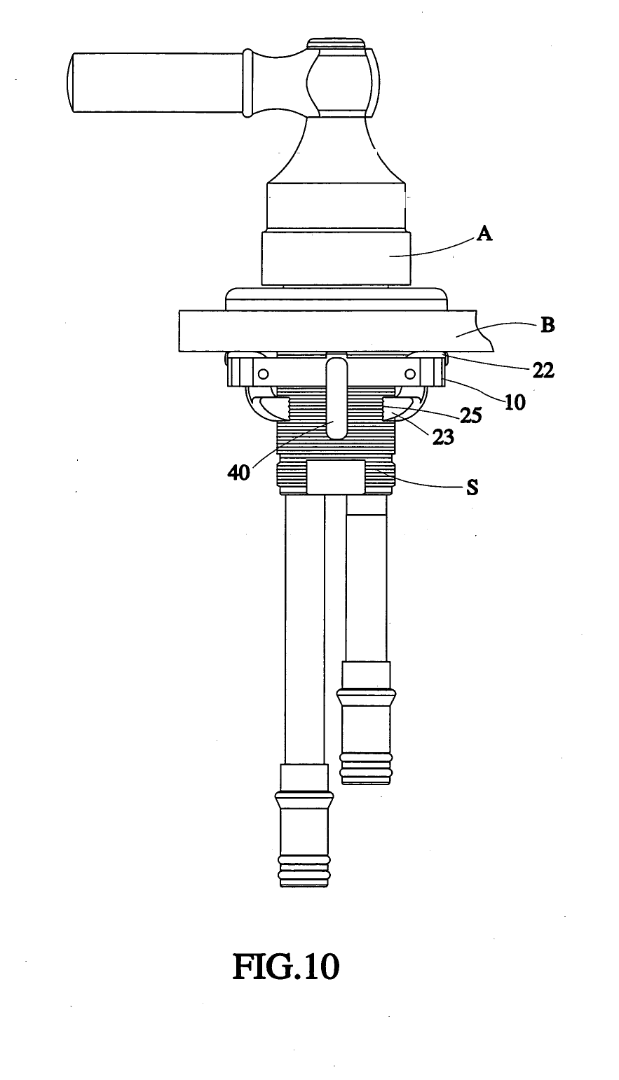

Referring to FIG. 6 to FIG. 10, the second embodiment of present invention has almost the same structures as the aforesaid embodiment. There is a main part 10, two swing arms 20 and two elastic members 30 still in this embodiment. But, in order to make the main part easily to rotate, there are two protrusions 40 on the outer side of the main part 10. Those two protrusions 40 placed on the main part 10 oppositely. Thus, user can rotate the main part 10 directly or push those two protrusions 40 to rotate the main part 10 easily and quickly when secure or lose the main part 10. No more hand tool or wrench will be needed when secure or lose the main part to a target object A.

The quantity of the pivot seat 12 and swing arm 20 as disclosed in aforesaid embodiments is not limited. The main part 10 can provide three, four or five pivot seat 12 and the same number of the swing arms 20 and also can achieve the same function and object.

What is claimed is:

1. A quick assembling nut, comprising: a main part, two swing arms and two elastic members;
the main part provides with a penetrating hole and there are two pivot seats on the wall of the penetrating hole;
those two swing arms pivot on a corresponding pivot seat and One end of the swing arm bends to one side to form an against portion and the other end of the swing arm provides a grip portion, the grip portion has threads thereon, those two grip portion are placed face to face;
those two elastic members are placed individually in the pivot seat and between the swing arm and the main part for providing a tension to keep those two grip portions open in peacetime.

2. The quick assembling nut as claimed in claim 1, wherein the grip portion has an arc wall with threads thereon.

3. The quick assembling nut as claimed in claim 1, wherein those two against portion of swing arms bend outward of the main part.

4. The quick assembling nut as claimed in claim 1, wherein the against portion and the grip portion of a swing arm both protrudes out of the main part.

5. The quick assembling nut as claimed in claim 1, wherein the pivot seat of the main part has a receiving hole, the elastic member is placed in the receiving hole and One end of the elastic member is against on the bottom of the receiving hole and the other end protrudes out of the receiving hole and is against on the swing arm.

6. The quick assembling nut as claimed in claim 1, wherein the main part has two protrusions thereon and those two protrusions placed on the opposite of the main part.
